(19) United States
(12) Patent Application Publication
(10) Pub. No.: US 2005/0235511 A1
(43) Pub. Date: Oct. 27, 2005

(54) Radius gauge

(76) Inventor: George T. Tkachyk, Winnipeg (CA)

Correspondence Address: Robert W.B. BAILEY, Box 2, Station L, Winnipeg, MB, R3H 0Z4, CA

(21) Appl. No.: 10/832,393

(22) Filed: Apr. 27, 2004

(51) Int. Cl. G01B 3/00

(52) U.S. Cl. 33/555.1

(57) ABSTRACT

A radius gauge has a central slotted body with an indicator slide to indicate radii. The slide is connected by a scissors linkage to a fixed pivot adjacent a central fixed contact point. The scissors linkage has associated contact arms with movable side contact points. The central and side contact points can contact a surface, and uniquely position the indicator slide through the scissors linkage indicating the radius of the curve. The contact arms may be mounted on the scissors linkage for concave curves, or extend from it for convex curves. A variable arc can be attached to the contact points to fit existing curves.

The invention is directed to a mechanical radius gauge suitable for measuring the inner and outer radii of pipes, tubes and other curved surfaces.

### BACKGROUND AND PRIOR ART

Radius gauges are well known, and usually comprise a set of arcs of known radius which can be fitted to exterior and interior surfaces of pipes and tubes. An electronic version to measure the radius of a curved surface is commercially available, but applicant is not aware of its principles or internal mode of operation. Otherwise applicant has no knowledge of devices related to instant invention.

The invention comprises a main longitudinal body with a slot in which slides an indicator, the main longitudinal body ends in a central contact point. Paired arms on either side of the main longitudinal body provide movable side contact points. The side arms are mechanically linked to the indicator and movement of the side contact points relative to the central contact point moves the indicator. The indicator slides against an empirically derived scale giving the radius of the surface measured. The invention can measure either inner (concave) radii or outer (convex) radii. A variable arc can be attached to the contact points, three point contact is necessary in practice to define the true radius of a curve.

It is a principal object of the invention to provide a radius gauge comprising a central contact projection aligned with a central slot with an indicator slide associated with a scissors linkage, which has operatively associated therewith contact arms having side contact points spaced apart from the central contact point, so that when the central and side contact points touch a curved surface the scissors linkage locates the indicator slide uniquely for each radius of the curved surface. It is subsidiary object of the invention that the scissors linkage comprises paired indicator arms pivoting about a pivot pin in the indicator slide and paired pivot arms pivoting a pivot pin in the central projection, with each indicator arm linked to each pivot arm by a pivot pin. It is a further subsidiary object of the invention that each contact arm is linked to one of the pivot arms and projects beyond the central projection pivot to the side contact point, whereby the central and side contact points can touch a convex curved surface. It is a further subsidiary object of the invention that each contact arm is linked to one of the pivot arms and projects a distance less than the central projection pivot to the side contact point, whereby the central and side contact points can touch a concave curved surface. A further subsidiary object of the invention that each contact arm is pivotally linked to a pivot pin on each pivot arm, and each contact arm has a link arm having therein a slot slidably engaging a carriage bolt on the pivot arm, so the contact arm can be moved from a locked open position to a folded position, whereby the side contact points of the contact arms in locked open position together with the central contact point can touch a concave curved surface. A further subsidiary object of the invention that each contact arm is pivotally linked to a pivot pin on each pivot arm, and each contact arm has a recess to engage a carriage bolt the pivot arm, so the contact arm can be moved from a locked open position to an unlocked folded position, whereby the side contact points of the contact arms in open position together with the central contact point can touch a convex curved surface. A further subsidiary object of the invention is that the contact points have recesses to engage pins from a variable arc. A further subsidiary object of the invention is to provide a variable arc, attachable to the radius gauge, which is a flexible rectangular sheet, with paired end brackets and to engage the contact point recesses. A further subsidiary object of the invention is to provide flex aperture in the variable arc. Other objects will be apparent to those skilled in the art from the following specification, accompanying drawings and appended claims.

### DESCRIPTION OF THE INVENTION

The invention in one broad aspect is directed to a radius gauge, which has a main longitudinal body with a central contact projection at one end, and a central longitudinal slot aligned with the central contact projection. The slot has a first slot end nearer the projection and a second slot end further from the projection. Typically the body and projection have a common longitudinal axis. An indicator slide is slidably mounted in the slot. A scissors linkage joins the indicator slide to the longitudinal body being attached by a first pivot pin to the indicator slide and a second pivot pin to the body. The scissors linkage has operatively associated therewith contact arms, which have side contact points spaced apart from the central contact point. When these central and side contact points touch a curved surface the scissors linkage locates the indicator slide uniquely for each radius of the curved surface. The main longitudinal body conveniently has two planar faces. Preferably the indicator slide has at least one indicator point on at least one side of the slot. More preferably the longitudinal body has two opposed faces and at least one scale on one face extending along a side of the slot. This scale has marked thereon radii indicia corresponding to the position of the side contact points, at least one indicator point of the indicator slide indicating the radius on the scale corresponding to side contact point positions. Preferably the indicator slide has two plates, each plate abutting one face and extending across the slot. More preferably the indicator slide has a lock comprising a bolt passing through the plates and a brake knob threadably engaging the bolt. The pivot pins are perpendicular respectively to body and slide. Preferably the scissors linkage comprises paired indicator arms pivoting about the first indicator pivot pin and paired pivot arms pivoting about the second body pivot pin, each indicator arm being linked to each pivot arm by a hinge pivot pin. The hinge pivot pin is typically a pin or rivet passing through both arms. Preferably the paired indicator arms are pivotally mounted on the indicator pivot pin on either side of the indicator slide, while the paired pivot arms are pivotally mounted on the fixed pivot pin on either side of the projection. The pivot pins are typically a pin or rivet and extend on both sides of the indicator slide and the projection. The indicator arm on one side of the indicator slide is linked to the pivot arm on the same side of the contact projection by a first hinge pivot pin, the indicator arm on the other side of the indicator slide being linked to the pivot arm on the same side of the contact projection by a second hinge pivot pin. In one form each contact arm is linked to one of the pivot arms and the contact arm projects from the pivot arm beyond the second body pivot pin to the side contact point, whereby the central and side contact points can touch a convex curved surface. Preferably each contact arm is pivotally linked to a pivot pin on each pivot arm, and each contact arm has a recess to engage a carriage bolt on each pivot arm, so the contact arm can be moved from a locked open position to an unlocked folded position, whereby the side contact points of the contact arms in open position together with the central contact point can touch a convex curved surface. In another form each contact arm is linked to one each pivot arm and projects a distance less than the central projection point to a side contact point, whereby the central and side contact points can touch a concave curved surface. Preferably each contact arm is pivotally linked to a hinge pivot pin on each pivot arm, and each contact arm has a link arm having therein a slot slidably engaging a carriage bolt on the pivot arm, so the contact arm can be moved from an open position to a closed position, whereby the side contact points of the contact arms in open position together with the central contact point can touch a concave curved surface. Preferably a first pivot arm-contact arm pair is pivotally mounted and fixedly joined on a first side of the contact projection and a second pivot arm-contact arm pair is pivotally mounted and fixedly joined on a second side of the contact projection. Preferably the contact points have recesses to engage pins from a variable arc. The side contact points have one recess and the central contact point has two recesses. A variable arc may be employed with the radius gauge. This variable arc to engage the radius gauge comprises a flexible rectangular sheet, having paired metal end brackets to engage the side contact point recesses, and a center bracket to engage the central contact point recesses. More preferably the variable arc has flex apertures, which conveniently together form extended longitudinal triangles lying between the diagonals of the rectangular sheet separated by transverse strips. More preferably the sheet comprises any resilient material, such as metal, lexan, or materials of similar properties as known to those skilled in the art, such as engineering plastics.

In a further broad aspect the invention is directed to a radius gauge comprising a main longitudinal body having a central contact projection at one end, with a central longitudinal slot aligned with the central contact projection. This slot having a first slot end nearer the projection and a second slot end further from the projection. An indicator slide is slidably mounted in the slot, having at least one indicator point on at least one side of the slot. The indicator slide has two plates, each plate abutting one face and extending across the slot. The indicator slide has a lock comprising a bolt passing through the plates and a brake knob threadably engaging the bolt. The longitudinal body has two opposed faces and at least one scale on one face extending along a side of the slot, the scale having marked thereon radii indicia corresponding to the position of the side contact points. The indicator point(s) of the indicator slide indicating the radius on the scale corresponding to side contact point positions. A scissors linkage comprises paired indicator arms pivotally mounted on the first indicator pivot pin on either side of the indicator slide, and paired pivot arms are pivotally mounted on the fixed pivot pin on either side of the projection. The indicator arm on one side of the indicator slide is linked to the pivot arm on the same side of the contact projection by a first contact hinge pivot pin, the indicator arm on the other side of the indicator slide is linked to the pivot arm on the same side of the contact projection by a second contact hinge pivot pin. The scissors linkage has operatively associated therewith contact arms having side contact points spaced apart from the central contact point. When the central and side contact points touch a curved surface the scissors linkage locates the indicator slide uniquely for each radius of the curved surface. In one form each contact arm is pivotally linked to a hinge pivot pin on each pivot arm, and each contact arm has a link arm having therein a slot slidably engaging a rivet on the pivot arm, so the contact arm can be moved from an open position to a closed position, whereby the side contact points of the contact arms in open position together with the central contact point can touch a concave curved surface. In another form each contact arm is pivotally linked to a pivot pin on each pivot arm, and each contact arm has a recess to engage a carriage bolt on each pivot arm, so the contact arm can be moved from a locked open position to an unlocked folded position, whereby the side contact points of the contact arms in open position together with the central contact point can touch a convex curved surface.

### BRIEF DESCRIPTION OF THE DRAWINGS

FIG. 1 shows a top plan view of an embodiment of the invention.

FIG. 2 shows a top plan view of the embodiment of FIG. 1 in folded for carriage.

FIG. 3 shows a top plan view of another embodiment of the invention.

FIG. 4 shows a top plan view of the embodiment of FIG. 3 in folded for carriage.

FIG. 5 shows a back elevational view of a variable arc of the embodiment of FIG. 1.

FIG. 6 shows a side elevational view of the embodiment of FIG. 5.

FIG. 7 shows a front elevational view of the embodiment of FIG. 5.

FIG. 8 shows a side elevational part sectional view of an indicator slide of the embodiments of FIGS. 1 and 3.

FIG. 9 shows a side elevational sectional view of an outer contact hinge of the embodiment of FIG. 1.

FIG. 10 shows a side elevational view of a center contact hinge of the embodiment of FIG. 1.

FIG. 11 shows a side elevational view of a contact arm pivot arm lock assembly of the embodiment of FIG. 1.

FIG. 12 shows a top plan view of a locking assembly of the embodiments of FIG. 1.

FIG. 13 shows a top plan view of a locking assembly of the embodiments of FIG. 3.

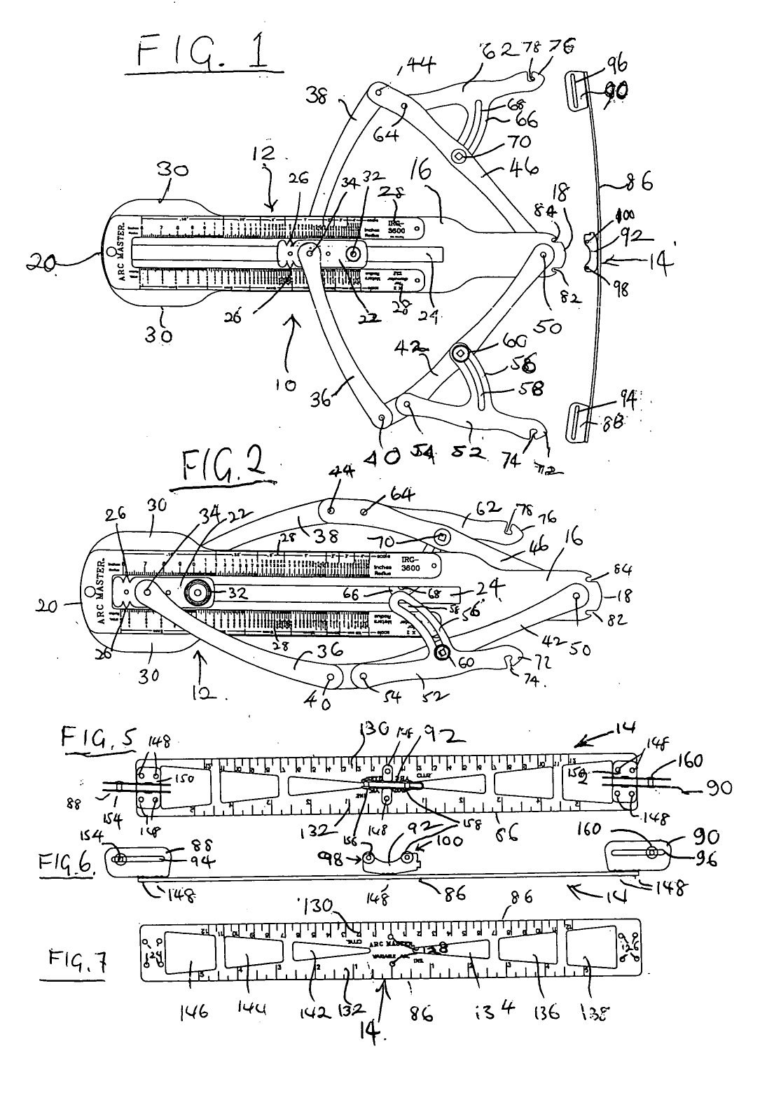

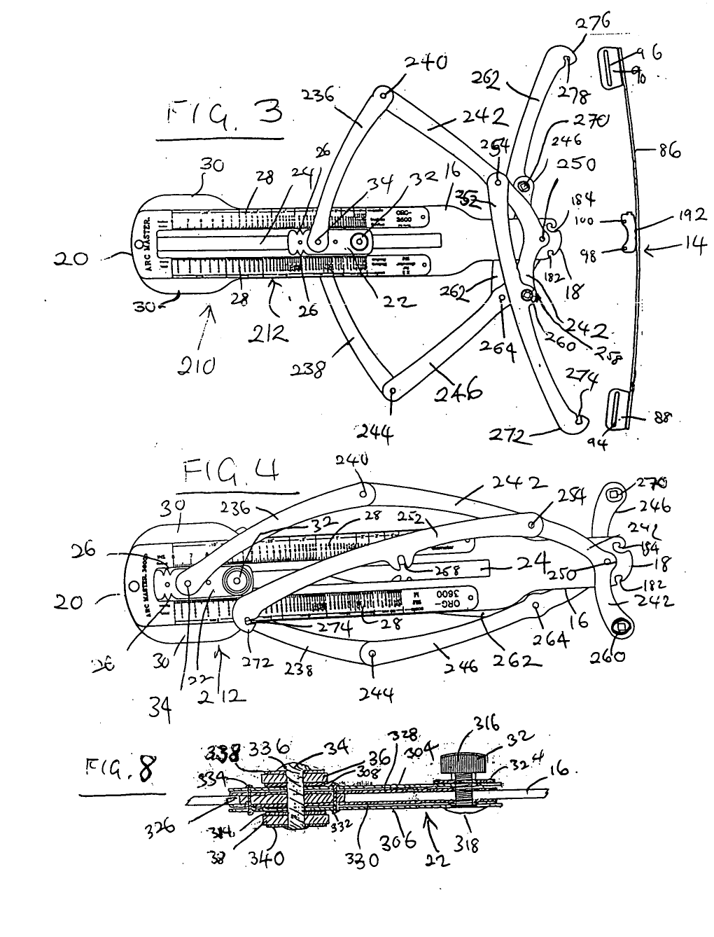

### DESCRIPTION OF THE PREFERRED EMBODIMENTS

Numeral 10 generally indicates the inner radius gauge to measure concave surfaces, having inner radius gauge 12 and preferred but optional variable arc 14. Radius gauge 12 has body 16, extending from center contact point 18 to end 20. Indicator slide 22 slides in slot 24, with indicator points 26 on either side, which indicate radius in either metric or imperial measures on scale plate 28. Radius gauge body 16 has optional end bulges 30, which were found when present to make handling easier. Indicator slide 22 has also has brake or locking knob 32 and indicator hinge 34. Pivotally attached to indicator slide 22 by indicator hinge 34 is upper indicator arm 36 and lower indicator arm 38. Indicator arm 36 is pivotally attached at outer pivot hinge 40 to pivot arm 42, similarly indicator arm 38 is pivotally attached at outer pivot hinge 44 to pivot arm 46. Pivot arms 42 and 46 are both pivotally attached to center contact hinge 50. Contact arm 52 is pivotally attached to pivot arm 42 by contact hinge 54, link arm 56 and link arm slot 58 engage locking nut bolt assembly 60, allowing contact arm 52 to be moved from an extended measuring position to a folded collapsed position. Similarly contact arm 62 is pivotally attached to pivot arm 46 by contact hinge 64, link arm 66 and link arm slot 68 engage locking nut bolt assembly 60, allowing contact arm 62 to be moved from an extended measuring position to a folded collapsed position. Contact arm 52 has outer contact point 72 with associated retention recess 74, contact arm 62 has outer contact point 76 and associated retention recess 78. Center contact point 18 has paired retention recesses 82 and 84. Optional variable arc 14 has flexible body 86, end brackets 88 and 90 and center bracket 92. End brackets 88 and 90 have slots 94 and 96 respectively allowing attachment to recess 74 in contact arm point 72 and to recess 78 in contact arm point 76 by rivets or pins which allow allow limited movement of brackets 88 and 90 with respect to contact arms 54 and 62. Center bracket 92 has paired apertures 98 and 100 which similarly allow attachment by rivets or pins to recesses 82 and 84 in center contact point 18. Variable arc 14 is flexible allowing it to fit curved surfaces, with center bracket 92 fixed relative to gauge body 16 and center contact point 18, while outer brackets 88 and 90 can move with respect to contact arm points 72 and 74 to allow variable arc 14 to conform to curvature of a surface measured. FIG. 2 shows radius gauge 12 folded for carriage, link arms 56 and 66 are released, slid inward and secured by locking nut bolt assemblies 60 and 70. The embodiment of FIGS. 1 and 2 shows a particular version of this embodiment, originally indicator arms 36 and 38 and pivot arms 42 and 46 were straight rather than curved, it was found that curving these arms as shown made folding for carriage easier, reducing wear and tear. Also originally pivots 40 and 54 and pivots 44 and 64 formed a single pivot each, for arms 36, 42 and 52 and arms 38, 46 and 62. This three level pivot arrangement was found unwieldy and less stable, than the double pivot arrangement shown in FIGS. 1 and 2. The contact arm-pivot arm join can be made rigid, which prevents folding and is inconvenient for carriage.

Outer radius gauge 210 is generally similar to inner radius gauge 10, and measures convex surfaces having outer radius gauge 212 and preferred but optional variable arc 14, identical to that associated with inner radius gauge 10. Radius gauge 212 has body 16, extending from center contact point 18 to end 20. Indicator slide 22 slides in slot 24, with indicator points 26 on either side, which indicate radius in either metric or imperial measures on scale plate 28. Radius gauge body 16 has optional end bulges 30, which were found when present to make handling easier. Indicator slide 22 has also has brake or locking knob 32 and indicator hinge 34. Pivotally attached to indicator slide 22 by indicator hinge 34 is upper indicator arm 236 and lower indicator arm 238. Indicator arm 236 is pivotally attached at outer contact hinge 240 to pivot arm 242, while indicator arm 238 is similarly pivotally attached at outer contact hinge 244 to pivot arm 246. Pivot arm 242 is pivotally mounted on center contact hinge 250 above body 16, while similarly pivot arm 246 is pivotally mounted on center contact hinge 250 below body 16. Contact arm 252 is pivotally mounted by contact hinge 254 on and above pivot arm 242, which has locking nut bolt assembly 260 which engages recess 258 of contact arm 252. Contact arm 252 has terminal outer contact point 272 with retention recess 274. Contact arm 262 is pivotally mounted by contact hinge 264 below above pivot arm 246, which has locking nut bolt assembly 270 which engages a recess of contact arm 262. Contact arm 262 has terminal outer contact point 276 with retention recess 278. Optional variable arc 14 is identical to that of FIG. 1. End brackets 88 and 90 have slots 94 and 96 respectively allowing attachment to recess 274 in contact arm point 272 and to recess 278 in contact arm point 276 by rivets or pins which allow limited movement of brackets 88 and 90 with respect to contact arms 54 and 62. Center bracket 92 has paired apertures 98 and 100 which similarly allow attachment by rivets or pins to recesses 182 and 184 in center contact point 18. Variable arc 14 is flexible allowing it to fit curved surfaces, with center bracket 92 fixed relative to gauge body 16 and center contact point 18, while outer brackets 88 and 90 can move with respect to contact arm points 272 and 274 to allow variable arc 14 to conform to curvature of a surface measured. Although shown convex in FIG. 3, variable arc 14 readily conforms to concave surfaces. FIG. 4 shows radius gauge 212 folded for carriage, contact arms 252 and 262 are released and slid inward. The nut end of locking nut bolt assembly 260 is shown as is the bolt end of locking nut bolt assembly 270. The embodiment of FIGS. 3 and 4 shows a particular version of this embodiment, originally indicator arms 236 and 238 and pivot arms 242 and 246 were straight rather than curved, it was found that curving these arms as shown made folding for carriage easier, reducing wear and tear. Also originally pivot arms 242 and 246 and contact arms 252 and 262 all pivoted on central contact hinge 250 forming a five level pivot, which proved less stable than the current three level pivot at central contact hinge 250 (or that at central contact hinge 50 of FIGS. 1 and 2). The contact arm-pivot arm join can be made rigid, which prevents folding and is inconvenient for carriage.

Variable arc 14 is flexible sheet 86, formed of 0.1 in. (2½ mm) resilient material, such as metal, lexan or material of similar properties known to those skilled in the art, such as engineering plastics. Sheet 86 has flex apertures 134, 136, 138, 140 and 142, 144, 146 of general triangular (134, and 142) and trapezoidal (136, 138, 144, and 146) shape, which allow flexing of the variable arc to conform to a surface, these apertures have rounded apexes to avoid cracking from fatigue. The apertures generally conform to an extended triangle formed by the diagonals of variable arc 14 separated by transverse strips for reinforcement. Sheet 86 has end attachment apertures 124 and 126 for attachment of metal end brackets 96 and 98 and center attachment apertures 128 for attachment of center bracket 100. Scales 130 (metric) and 132 (imperial) are present (as shown they are reversed as they would be readable from the gauge or back side of variable arc 14). Eyelets 148 attach brackets 88, 90 and 92 to variable arc 14. Apertures 124 and 16 are grouped as close as possible since attachment plates 150 and 152 of brackets 88 and 90 form a rigid plane, making the ends of variable arc tangential rather than circumferential. ⅛ inch (3 mm) rivet 154 in slot 94 of bracket 88, rivets 156 and 158 in apertures 98 and 100 of bracket 92 and rivet 160 in slot 96 of bracket 90, engage retention recesses 74, 78, 82 and 84 of inner radius gauge 10, and retention recesses 74, 78, 182 and 184 of outer radius gauge 210. The brackets are 0.035 inch (0.9 mm) steel.

FIG. 8 shows indicator slide 22, which has indicator hinge 34 including semitubular rivet 336, which passes through upper indicator arm 36, upper indicator plate 304, upper cushioning slide 328, centering slide 326, lower cushioning slide 330, lower indicator plate 306, and lower indicator arm 38, allowing free pivotal movement of indicator arms. Centering slide 326 of nylon 0.125 in. (3 mm) thick, slides in slot 24, cushioning slides, upper 328, lower 330 of polyethylene 0.03 in. (¾ mm) thick, ride on either surface of body 16, allowing free longitudinal movement. Nylon washers 338, 308, 314 and 340 separate moving parts, allowing pivotal motion of indicator arms 36 and 38. Blind aluminum rivets 332 and 334 pass through top indicator plate 304, upper cushioning slide 328, centering slide 326, lower cushioning slide 330 and bottom indicator plate 306. Semitubular rivet 336 is physically located in slot 24 and thus does not contact radius gauge body 16. Brake knob 32 has thumb nut 316 threadably engaging carriage bolt 318 passing through upper indicator plate 304, upper cushioning slide 328, lower cushioning slide 330 and lower indicator body 306, allowing thumb nut 316 to tighten on bolt 318 and lock indicator slide 22 in position. Optional washer 324 may be present between thumb nut 316 and upper indicator plate 302. Indicator plates 302, 304 are 0.030 inch (0.75 mm) stainless steel.

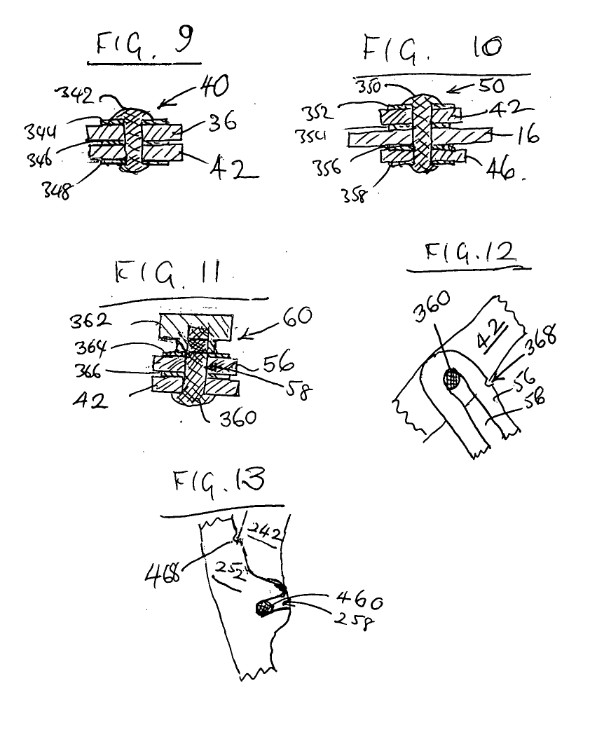

FIG. 9 shows outer contact hinge 40, semitubular rivet 342 passes through indicator arm 36 and pivot arm 42, nylon washers 344, 346 and 348 separate moving parts allowing free pivotal movement of the arms. Outer contact hinge 40 is identical in structure and function to contact hinges 44, 54, 64 of FIG. 1, and 240, 244, 254 and 264 of FIG. 3.

FIG. 10 shows center contact hinge 50, semitubular rivet 350 passes through pivot arm 42, gauge body 16, and pivot arm 46, nylon washers 352, 354, 356 and 358 separate moving parts allowing free pivotal movement of the arms. Center contact hinge 50 is identical in structure and function to center contact hinge 250 of FIG. 3.

FIG. 11 shows locking bolt nut assembly 60, carriage bolt 360 passes through pivot arm 52 and slot 58 in link arm 56, to engage thumb nut 362. Nylon washers 364 and 366 allow relative sliding movement of link arm 56. Locking bolt nut assembly 70 of FIG. 1, is identical in structure and function. Locking nut bolt assemblies 260 and 270 of FIG. 3, are almost identical, washer 364 is absent, so thumb nut 362 or equivalent would engage the equivalent of link arm 56. While assembly 60 never loses contact with link arm 56, contact arms 252 and 262 separate from pivot arms 242 and 246, otherwise structure and function are identical.

FIG. 12 shows how carriage bolt 360 fixed on pivot arm 42 fits snugly into slot 58 of link arm 56, when position indicator (notch) 368 in link arm 56 coincides with the edge of pivot arm 42, allowing a thumb nut to be tightened to lock link arm 56 in correct position. Similarly FIG. 13 shows how carriage bolt 460 similarly fits snugly into recess 258 of contact arm 252, when position indicator (notch) 468 coincides with the edge of pivot arm 242.

The elements are metal, powder coated, or anodized aluminum of 0.10 or 0.125 in. thickness (2½ to 3 mm), and are laser cut to shape for precision manufacture, 0.10 inch is preferred as it is easier to laser cut without edge slag formation. The powder coating may be clear, opaque and/or colored to taste. The nylon washers are generally 0.03 in. (¾ mm) thick with inner diameters suitable for the bolts, pins and rivets and appropriate outer diameters as is readily understood by those skilled in the art. Screws, bolts and nuts are stainless steel or zinc or similar appropriate material as readily understood by those skilled in the art. Thumb nuts can be any suitable material, as those skilled in the art are aware, but plastic is preferred for reduction of wear. The contact ends side and center in all cases have radii of 0.125 in. (3 mm). The scale board is 15/1000 in. (⅜ mm) thick and made from lexan, or materials of similar properties, as known to those skilled in the art, which is readily printed on, the printing is underneath and can be read through the board, so does not wear off.

In use the embodiments of FIGS. 1 and 3 have their contact arms slid out so their slides engage the pivot arms' stop pins (carriage bolts of the locking assemblies) where they are locked in position. In this position the contact arms are parallel to the gauge body. All three contact ends have radii of 0.125 in. (3 mm).

The scale markings of scale 28 were originally determined empirically, by marking indicator positions against known pipe diameters. An attempt was made to derive an equation which would give positions corresponding to diameters using a computer program, but this proved far beyond the skill or knowledge of the programmer, who was unable to produce a satisfactory working equation or program. The empirical scale positions were checked by simulating scale models of radius gauges of the invention, using AutoCAD, a computerised drawing program, and testing these against scale models of concave and convex arcs of known radius. The completed radius scales were then tested against known pipe diameters, internal and external, and found accurate within ½% for radii from 6 to 144 inches (150 to 3600 mm). As indicated on the scale board the markings are accurate to 1/1000 inch, with respect to their location. The movement of the scissors linkage multiplies the movement of the contact points by up to nine times. At 144 inches an inch difference in radius corresponds to about 1/1000 inch difference in outer contact point location, or a movement of about 9/1000 inch on the scale. The described embodiments are about 12 in. (30 cm) wide by about 16 in. (40 cm) long, these dimensions can be readily changed to measure larger or smaller radii.

As those skilled in the art would realize these preferred described details and materials and components can be subjected to substantial variation, modification, change, alteration, and substitution without affecting or modifying the function of the described embodiments.

Although embodiments of the invention have been described above, it is not limited thereto, and it will be apparent to persons skilled in the art that numerous modifications and variations form part of the present invention insofar as they do not depart from the spirit, nature and scope of the claimed and described invention.

1. Radius gauge comprising
a main longitudinal body having a central contact projection at one end,
and a central longitudinal slot aligned with said central contact projection
said slot having a first slot end nearer said projection and a second slot end further from said projection and
an indicator slide slidably mounted in said slot and
a scissors linkage joining said indicator slide to said longitudinal body being attached by a first pivot pin to said indicator slide and a second pivot pin to said body,
said scissors linkage having operatively associated therewith contact arms having side contact points spaced apart from said central contact point,
whereby when said central and side contact points touch a curved surface said scissors linkage locates said indicator slide uniquely for each radius of said curved surface.

2. Gauge of claim 1, wherein said indicator slide has at least one indicator point on at least one side of said slot.

3. Gauge of claim 2, wherein said longitudinal body has two opposed faces and at least one scale on one said face extending along a side of said slot, said scale having marked thereon radii indicia corresponding to the position of said side contact points, said at least one indicator point of said indicator slide indicating the radius on said scale corresponding to side contact point positions.

4. Gauge of claim 3 wherein said indicator slide has two plates, each plate abutting one said face and extending across said slot.

5. Gauge of claim 4 wherein said indicator slide has a lock comprising a bolt passing through said plates and a brake knob threadably engaging said bolt.

6. Gauge of claim 1, wherein said scissors linkage comprises paired indicator arms pivoting about said first indicator pivot pin and paired pivot arms pivoting about said second body pivot pin, each indicator arm being linked to each pivot arm by a hinge pivot pin.

7. Gauge of claim 6 wherein said paired indicator arms are pivotally mounted on said indicator pivot pin on either side of said indicator slide and
said paired pivot arms are pivotally mounted on said fixed pivot pin on either side of said projection and
the indicator arm on one side of said indicator slide is linked to the pivot arm on the same side of said contact projection by a first hinge pivot pin, the indicator arm on the other side of said indicator slide being linked to the pivot arm on the same side of said contact projection by a contact hinge pivot pin.

8. Gauge of claim 6, wherein each contact arm is linked to one of said pivot arms and said contact arm projects from said pivot arm beyond said second body pivot pin to said side contact point, whereby said central and side contact points can touch a convex curved surface.

9. Gauge of claim 6, wherein each contact arm is pivotally linked to a pivot pin on said pivot arm, and each contact arm has a recess to engage a carriage bolt on said pivot arm, so the contact arm can be moved from a locked open position to an unlocked folded position, whereby the side contact points of said contact arms in open position together with the central contact point can touch a convex curved surface.

10. Gauge of claim 6, wherein each contact arm is linked to one said pivot arm and projects a distance less than said central projection point to a side contact point, whereby said central and side contact points can touch a concave curved surface.

11. Gauge of claim 6, wherein each contact arm is pivotally linked to a hinge pivot pin on said pivot arm and each contact arm has a link arm having therein a slot slidably engaging a carriage bolt on said pivot arm, so said contact arm can be moved from an open position to a closed position, whereby said side contact points of said contact arms in open position together with said central contact point can touch a concave curved surface.

12. Gauge of claim 1, wherein said contact points have recesses to engage pins from a variable arc.

13. Gauge of claim 13, wherein said side contact points have one said recess and said central contact point has two recesses.

14. Variable arc to engage the gauge of claim 12, comprising a flexible rectangular sheet, having paired metal end brackets to engage said side contact point recesses, and a center bracket to engage said central contact point recesses.

15. Variable arc of claim 14, comprising flex apertures.

16. Variable arc of claim 15, wherein said flex apertures together form extended longitudinal triangles lying between the diagonals of said rectangular sheet separated by transverse strips.

17. Variable arc of claim 14, wherein said sheet comprises clear thin plastic.

18. Radius gauge comprising
a main longitudinal body having a central contact projection at one end,
and a central longitudinal slot aligned with said central contact projection
said slot having a first slot end nearer said projection and a second slot end further from said projection and
an indicator slide slidably mounted in said slot, having at least one indicator point on at least one side of said slot, and said indicator slide has two plates, each plate abutting one said face and extending across said slot, and
said indicator slide has a lock comprising a bolt passing through said plates and a brake knob threadably engaging said bolt, and
said longitudinal body has two opposed faces and at least one scale on one said face extending along a side of said slot, said scale having marked thereon radii indicia corresponding to the position of said side contact points, said at least one indicator point of said indicator slide indicating the radius on said scale corresponding to side contact point positions, and
a scissors linkage comprising paired indicator arms pivotally mounted on said first indicator pivot pin on either side of said indicator slide,
paired pivot arms are pivotally mounted on said fixed pivot pin on either side of said projection and
the indicator arm on one side of said indicator slide is linked to the pivot arm on the same side of said contact projection by a first contact hinge pivot pin, the indicator arm on the other side of said indicator slide being linked to the pivot arm on the same side of said contact projection by a second contact hinge pivot pin,
said scissors linkage having operatively associated therewith contact arms having side contact points spaced apart from said central contact point,
whereby when said central and side contact points touch a curved surface said scissors linkage locates said indicator slide uniquely for each radius of said curved surface.

19. Gauge of claim 18, wherein each contact arm is pivotally linked to a hinge pivot pin on said pivot arm, and each contact arm has a link arm having therein a slot slidably engaging a carriage bolt on said pivot arm, so said contact arm can be moved from an open position to a closed position, whereby said side contact points of said contact arms in open position together with said central contact point can touch a concave curved surface.

20. Gauge of claim 18, wherein each contact arm is pivotally linked to a pivot pin on said pivot arm, and each contact arm has a recess to engage a carriage bolt on said pivot arm, so the contact arm can be moved from a locked open position to an unlocked folded position, whereby the side contact points of said contact arms in open position together with the central contact point can touch a convex curved surface.
